(19) United States
(12) Patent Application Publication
(10) Pub. No.: US 2005/0187910 A1
(43) Pub. Date: Aug. 25, 2005

(54) Embedded electronic searching device for books

(76) Inventor: Konstantin Kladko, Palo Alto, CA (US)

Correspondence Address: Konstantin Kladko, 1735 Woodland Ave, # 10, Palo Alto, CA, 94303, US

(21) Appl. No.: 10/784,683

(22) Filed: Feb. 23, 2004

(51) Int. Cl. G06F 7/00

(52) U.S. Cl. 707/3

(57) ABSTRACT

My invention presents a simple, non-expensive embedded searching device, which greatly improves book usage, especially for large books which contain lots of information. Although the description above contains many specificities, these should not be construed as limiting the scope of the embodiments of the invention but as merely as providing illustrations of some possible embodiments of this invention.

### CROSS-REFERENCE TO RELATED APPLICATIONS

The present application claims priority to the provisional patent Application entitled “EMBEDDED ELECTRONIC SEARCHING DEVICE FOR BOOKS” filed on Feb. 24, 2003, Application No. 60/449,145

### BACKGROUND OF THE INVENTION

1. Field of the Invention

This invention relates to electronic searching devices for books and other printed materials.

2. Background of the Invention

Books and printed materials, such as magazines and newspapers, are commonly used means to publish and disseminate information.

In many cases, books may have thousands of pages, and contain significant amount of information. Examples of such voluminous books include catalogues, textbooks, encyclopedias, and yellow pages. Many professionals routinely deal with large books. Lawyers daily work with volumes of laws, legal regulations, and cases. Sales professionals work with catalogues of items for sale. College students use large, multiple-page textbooks.

The problem, which embodiments of this invention address, is searching a large book for a particular piece of information. Currently, this may be a very painful, time-consuming process.

The commonly used solution for this problem is the book index, which is commonly printed at the end of the book. The index contains a set of index keywords. For each keyword, it lists the set of pages, which contain this particular keyword.

The printed book index has many limitations.

First, it does not list all the words used in the book, only a subset of these words. This subset is often manually created by the author. If a particular word is not an index keyword, the reader has no means to search for this word.

Second, the index itself may have multiple pages, therefore, looking up the index for a particular keyword is a time consuming task.

As an example, “Intellectual Property in the New Technology Age” by Merges et al, Aspen Law, 2000, contains 1024 pages. From them, all the various indices, such as index of cases, index of statutes, and main index, take 24 pages. Searching such an extended index for a particular piece of information may be a very time consuming task.

Third, the index does not allow searches for word combinations, and logical constructions. Examples of such constructions include:
Searching a legal case book for all year 1998 cases which are all related to patent protection
Searching a recipe book for all recipes which contain milk and eggs, but do not contain flour
Searching Yellow pages for all auto repair shops which are located on Green Street, and which repair breaks
Searching a physics textbook for all discoveries made by US scientists

Embodiments of our invention solve these problems by embedding an electronic searching and indexing device into the book, and allowing arbitrary searches of book contents.

Fourth, the book indices are not standardized, each book has index in its own form, and some books do not have indices at all. The quality of the book index varies greatly from book to book. The reader must learn how to use the index for each particular book she has.

### SUMMARY

In accordance with the present invention, an embedded electronic searching device is an electronic device, which is embedded into the book and enables search queries on the book contents, with results displayed to the user.

### DRAWINGS—FIGURES

The attached figures are included for illustration purposes only and should not be construed to limit the possible embodiments of the invention in any way.

FIG. 1 illustrates schematics of the device in one embodiment, top view, the front cover of a book according to one embodiment of the invention.

FIG. 2 shows the main electronic components of the device according to one embodiment of the invention.

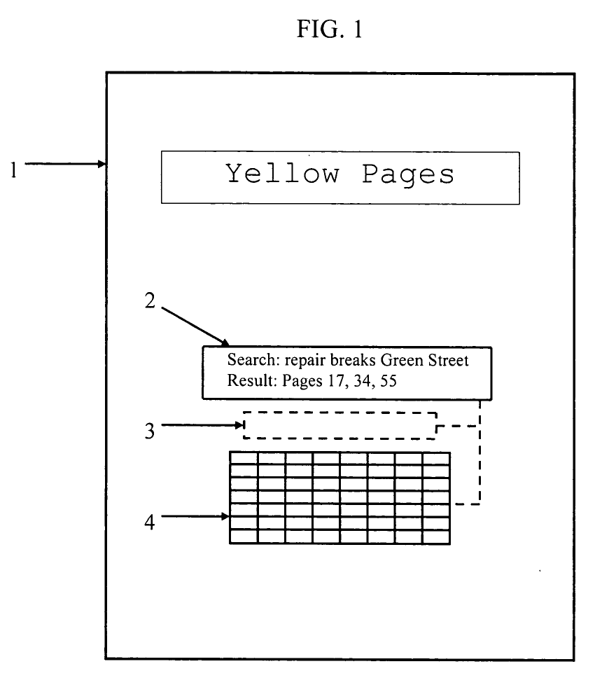

### DETAILED DECRIPTION—FIGS. 1A AND 1B—ONE EMBODIMENT

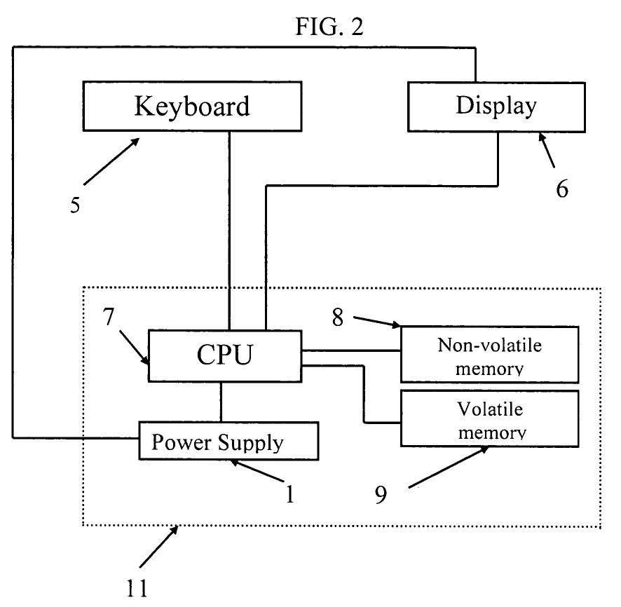

One embodiment of the present invention is illustrated in FIG. 1 (top view of the book cover) and FIG. 2 (main electronic components of the device).

The device has a display 2, which in one embodiment is placed on the front cover of the book 1. In one embodiment the display 2 is a liquid crystal display (LCD) which is commonly used in consumer devices.

The device has a system block 3, which in one embodiment is hidden in the front cover of the book. In one embodiment the system block is placed between the two sheets of paper, and glued in such a way, that it is not seen by the reader. However, the system block may be placed in other places in the book, such as the back cover, and may be seen by the reader, and not hidden.

The system block device 3 in one embodiment consists of electronic components that are necessary for device operation, and the power supply. The detailed description of the system block for one embodiment is given later in this section.

The keyboard 4 is, in one embodiment, glued into the front cover of the book. However, it may also be printed on the front cover, or placed in any other reasonable way. The keyboard 4, in one embodiment, has buttons for English letters from A to Z, digits from 1 to 10, a “Shift” button which allows to enter capital letters, a “Backspace” button, which allows to erase the last letter entered, a “Cancel” button, which allows to cancel the current operation, and a “Search” button, which allows to perform a search on the book contents. However, the keyboard may have other design.

Both the keyboard 4 and the display 2 are physically connected to the system block 3. In one embodiment the connectors are electric cables, which are glued into the book's front cover. However, one may use any other kind of connectors, as soon as they support sending electronic signals to the display, and receiving key strokes from the keyboard.

The system block 3, in one embodiment, has non-volatile memory 9. The non-volatile memory 9 stores the book's index. The book's index, in one embodiment, for each word used in the book lists the pages on which this word has occurred, and number of occurrences of this word. However, the index may store any other information about the contents of the book, such as the number of chapters, the size of each chapter, the title of each chapter, etc.

In one embodiment, the non-volatile memory also contains the software, necessary for device operation, namely the device initialization software, which is run on boot up, and the search software, which performs a search on the index, given a search query.

However, the non-volatile memory may contain any other software and data necessary for device operation, such as utilities for book marking particular pages, adding notes etc.

In one embodiment, the non-volatile memory is flash Read Only Memory (ROM) commonly used in consumer electronics. However, the non-volatile memory may be any other kind of non-volatile memory.

The system block 3 has volatile memory 10. In one embodiment we use common Random Access Memory (RAM) used in computers and consumer devices. However, the volatile memory may be any other kind of memory which allows read and write operations, such as flash memory.

The volatile memory holds the data and variables related to the current search and other data and variables used by device software.

The Central Processing Unit (CPU) 7 is a processor, which runs the search software and computes the search results.

The power supply 10 is, in one embodiment, a common electric battery used in consumer devices. However, the power source may be any other source of electric power, such as a solar battery.

In one embodiment embodiment, the memory, CPU, and the power supply are plugged into an electronic board 11, and form the system block 3. However, the aforementioned electronic components 7, 8, 9, 10 may be assembled and connected in other way, and using any other additional electronic elements.

### DETAILED DECRIPTION—OPERATION

In a typical usage scenario and in one embodiment, the operation of the device consists of the following steps:
1. The user types in a search query using the keyboard. As an example, let us assume that the reader want to search a cook book for all recipes that contain milk, eggs and flour. In this case the reader will type
   “milk eggs flour”
2. The device will search the search index, and output all the pages that match the query. In the particular example, the device will find all pages that contain the three words milk, eggs and flour, and the output on the display will look in the following way:
   “Search results: Pages 12, 34, 56”

The user may then look up the corresponding pages.

In an advanced usage scenario, the query may contain logical operators AND, OR and NOT.

As an example, if the reader is interested in all recipes, which contain eggs, milk, but no meat, the reader may type a query:
“eggs AND milk NOT meat”.

In this example, the device will perform a search, an output all book pages, which contain eggs and milk, but do not contain meat.

The device may output other information for each search result, such as chapter number, chapter name, etc.

The device may support bookmarking pages and making notes. The user may be able to bookmark a particular search result for fast retrieval in the future. The user may also be able to use device to leave notes related to book contents.

The device may be attached to the book using means which allow detachment and then reattachment. As an example in one embodiment it can be attached to the book using Velcro-like fastener.

Accordingly, several objects and advantages of the present invention are:
a) We empower the book's reader with a simple, small, and inexpensive electronic searching device which is embedded into the book. When mass produced, the device may have dimensions of a credit card, and the price of an inexpensive calculator. For user convenience, the device may be embedded or glued into the book's front cover, or added to the book in any other convenient way.
b) The reader does not have to read the book's index to search for a particular piece of information. Instead, the reader types a search query using the device keyboard, which may be embedded or printed on the front cover of the book. As a response to the query, a list of page numbers for matching pages is displayed on the device's display.
c) The user may have queries with multiple words and logical expressions. As an example, to search yellow pages for all auto repair shops on Green Street, which repair breaks, the reader would type
   “auto repair breaks Green Street”
d) Using modern electronic technology the device may be in a very small size (credit card size), and may actually take less space, then the printed index.
e) The device will have a standardized interface. This means, that if the reader has many books, she has to learn using the search device only once.

1. An electronic search device for a book configured to attach to the book, to comprise information describing book's contents and to generate search results in response to a search query utilizing the information describing the book's contents and to display the search results.

2. The device of claim 1 wherein said search results comprise page numbers.

3. The device of claim 1 wherein said book is of Yellow Pages or White Pages type.

4. The device of claim 1 wherein said search results comprise quotations from book contents.

5. The device of claim 1 wherein said search results comprise contact information.

6. The device of claim 1 wherein said search results comprise driving directions.

7. The device of claim 1 wherein said search results comprise advertisements.

8. The device of claim 1 wherein the device is configured to be embedded into the book's cover.

9. The device of claim 1 wherein the device is configured to be attached to the book using means which allow detachment, and then reattachment.

10. The device of claim 1 wherein said book comprises maps.

11. The device of claim 1 wherein said book is a catalogue.

12. The device of claim 1 wherein said device is configured to store past search queries as bookmarks.

13. The device of claim 1 wherein said device is configured to store user notes related to book contents.

14. The device of claim 1 further comprising of an output device, an input device, a processor, a memory, a power source.

15. The device of claim 14 wherein said input device is a keyboard.

16. The device of claim 14 wherein said input device is a radio or infrared receiver.

17. The device of claim 14 wherein said output device is an electronic display.

18. The device of claim 14 wherein said output device is a radio or infrared transmitter.

19. The device of claim 14 wherein said power source is a battery.

20. The device of claim 14 wherein said power source is based on solar power.
